(19) United States
(12) Patent Application Publication
(10) Pub. No.: US 2014/0006459 A1
(43) Pub. Date: Jan. 2, 2014

(54) RULE-BASED AUTOMATED TEST DATA GENERATION

(71) Applicants: Bin Guo, Shanghai (CN); Qi-Bo Ma, Shanghai (CN); Yi-Ming Ruan, Shanghai (CN)

(72) Inventors: Bin Guo, Shanghai (CN); Qi-Bo Ma, Shanghai (CN); Yi-Ming Ruan, Shanghai (CN)

(73) Assignee: HEWLETT-PACKARD DEVELOPMENT COMPANY, L.P., Fort Collins, CO (US)

(21) Appl. No.: 13/813,646

(22) PCT Filed: Jun. 29, 2012
(86) PCT No.: PCT/CN2012/077903

§ 371 Date: Jan. 31, 2013

(51) Int. Cl. G06F 17/30

(52) U.S. Cl. CPC G06F 17/30292
USPC 707/805; 707/803

(57) ABSTRACT

Example embodiments disclosed herein relate to a rule-based data population system including a rule dispatcher engine to automatically bind data generating rules to a database. The system may further include a data generator engine to generate testing data for the database based on the rules.

### BACKGROUND

Performance testing is essential for quality assurance of software. A reliable performance testing depends largely on proper testing data. Software developers and manufacturers are challenged with providing testing data for testing software database, where such testing data are aligned to customers' data. As a result, numerous defects related to performance of software are missed during testing and are subsequently reported by customers after the software is deployed, because the performance testing data was not properly aligned to the customers' real data.

### BRIEF DESCRIPTION OF THE DRAWINGS

FIG. 1 depicts an environment in which various embodiments may be implemented.

FIGS. 2A and 2B depict a rule-based data population system according to an example;

FIGS. 3A-3B depict an example implementation of a processor and a computer-readable storage medium encoded with instructions for implementing a rule-based data populating method;

FIG. 4 depicts another example of a rule-based data population system;

FIG. 5 is a block diagram depicting an example implementation of the system of FIGS. 2A-2B and 4;

FIG. 6 is a flowchart of an example implementation of a method for rule-based data population; and

FIG. 7 is a flowchart of another example implementation of a method for rule-based data population.

### DETAILED DESCRIPTION

INTRODUCTION: Various embodiments described below were developed to provide a rule-based data population system for testing a database, for example, during performance testing stage. There are numerous challenges to populating performance testing data. For example, there may be hundreds of tables in a database that make it laborious to analyze data constraints for each of the tables and to manually generate data patterned to each of the tables. Thu, it would be desirable to implement a testing tool that automatically generates testing data tailored to the specific structures of the database tables. Several data relationships are defined in the software programs and these relationships may not be reflected in the database constraints. Accordingly, performance testing data and software business logic knowledge may be required to determine the type of performance testing data to populate the database for testing purposes. Hence, a platform may be needed to enable the software architect, who has knowledge of the software business logic, to provide such inputs and a performance tuning architect, who has testing design knowledge, to provide such inputs to configure the testing tool in order to generate relevant performance testing data. Also, some data structures in the database may be too specific (i.e., tailored to a specific business need) or complicated, making it difficult to develop data populating tools that support such data structures to guarantee their integrities. Thus, it would also be desirable to develop data testing tools that are reusable (i.e., generic) for performance testing on different software having different databases of varying complexities. The described embodiments provide a testing tool to address the above challenges and needs. The described embodiments reduce the number of performance defects that escape detection during testing and later discovered by customers, by providing a robust testing tool.

An example implementation includes providing data generating rules for a database. The data generating rules include data constraints (e.g., entity relationship diagram (ERD)), Further, data scales may be specified for the database tables and columns. In one embodiment, rule instances that describe testing data to be generated are created where the rule instances include database rule instances, table rule instances, and column rule instances. The implementation also includes automatically binding the data generating rules to the database. For example, the data generating rules are bound to columns and tables of the database. The implementation further includes generating testing data based on the data generating rules. For example, the testing data may be output as a structured query language (SQL) script file, a spreadsheet file, a test file, a standard tester data format (STDF) file, or other script file formats that may be used to inject the generated data into the software during performance testing.

The following description is broken into sections. The first, labeled “Environment,” describes an example of a network environment in which various embodiments may be implemented. The second section, labeled “Components,” describes examples of physical and logical components for implementing various embodiments. The third section, labeled “Operation,” describes steps taken to implement various embodiments.

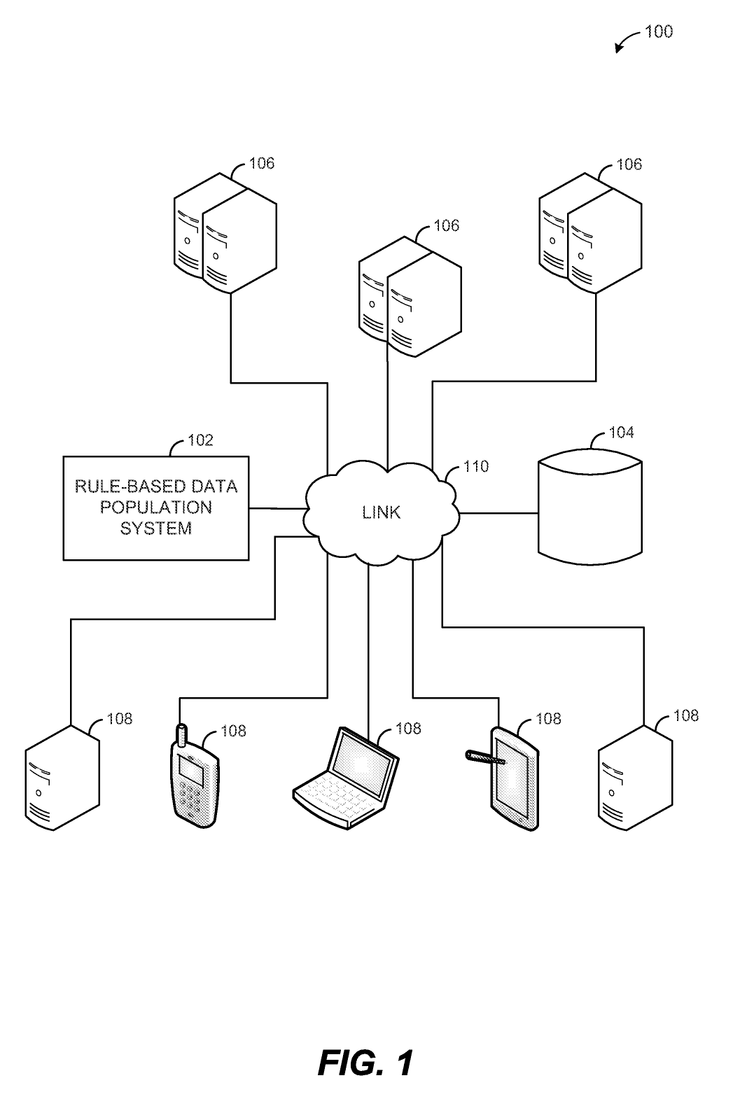

ENVIRONMENT: FIG. 1 depicts an environment 100 in which various embodiments may be implemented. Environment 100 is shown to include rule-based data population system 102, data store 104, server devices 106, and client devices 108. Rule-based data population system 102 described below with respect to FIGS, 2A-2B, 3A-3B, 4, and 5, represents generally any combination of hardware and programming configured to generate testing data based on provisioned data generating rules. Data store 104 represents generally any device or combination of devices configured to store data for use by rule-based data population system 102. Such data may include database information 114, data schema, the data generating rules, data patterns and trends, and historical testing data.

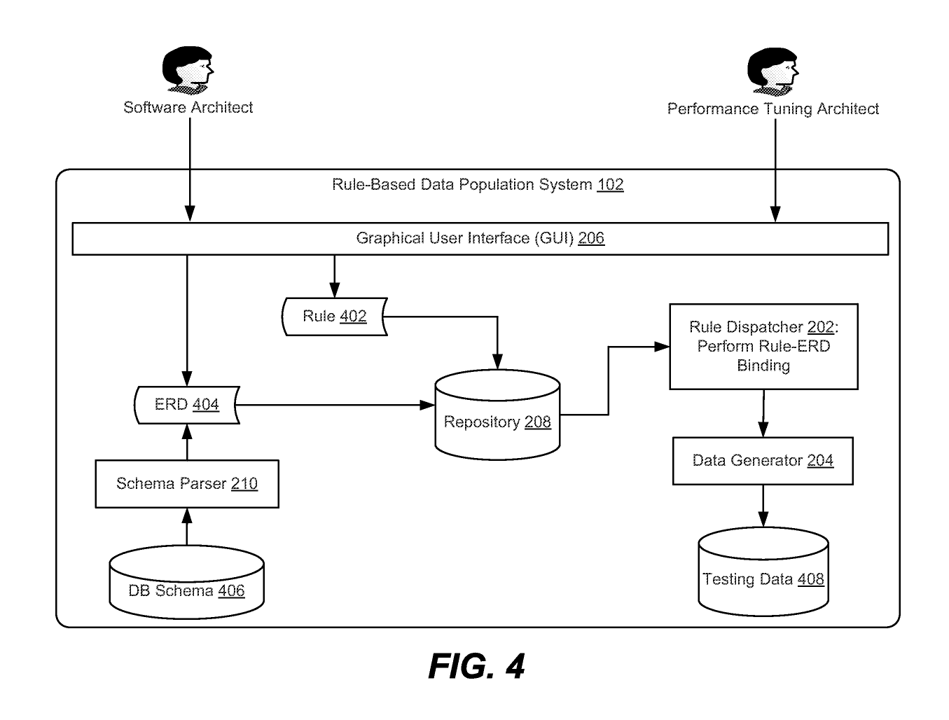

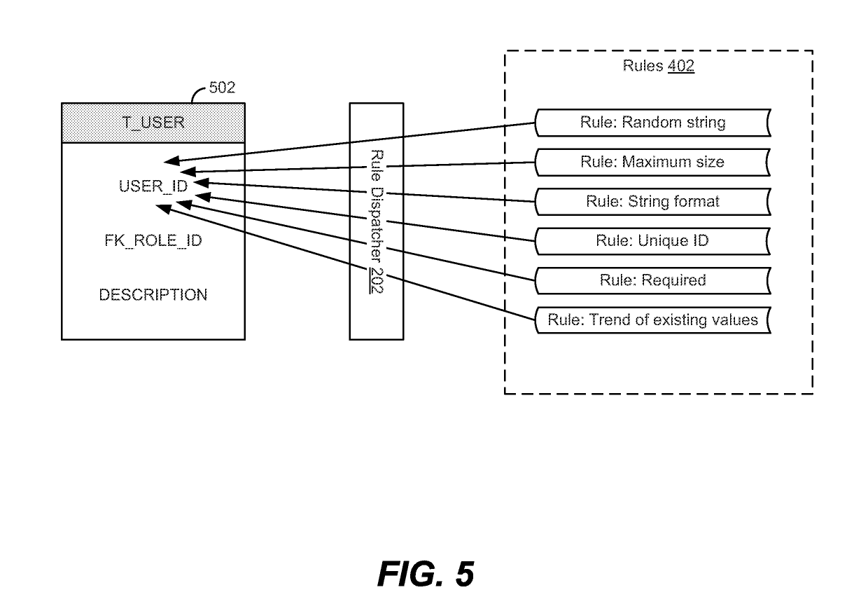

In the example, of FIG. 1, the data generating rules represent data constraints including ERD provisioned and/or recorded in the data store 104 or communicated between one or more server devices 106 and one or more client devices 108. Server devices 106 represent generally any computing devices configured to respond to network requests received from client devices 108. A given server device 106 may include a web server, an application server, a file server, or a database server. Client devices 108 represent generally any computing devices configured with browsers or other applications to communicate such requests and receive and process the corresponding responses. Link 110 represents generally one or more of a cable, wireless, fiber optic, or remote connections via a telecommunication link, an infrared link, a radio frequency link, or any other connectors or systems that provide electronic communication. Link 110 may include, at least in part, an intranet, the Internet, or a combination of both. Link 110 may also include intermediate proxies, routers, switches, load balancers, and the like. FIG. 4 depicts an example implementation of one or more users (e.g., a software architect and a performance tuning architect) interacting with the system 102 to configure the system for data generation. To illustrate, the software architect and the performance tuning architect may provide configuring inputs (e.g., data generating rules) to the system 102 via one or more client devices 108, and/or requests from server devices 106 (e.g., a database server). Client devices 108 may include, for example, a notebook computer, a desktop computer, a laptop computer, a handheld computing device, a mobile phone or a smartphone, a slate or tablet computing device, a portable reading device, or any other processing device. FIG. 5 depicts an example of automatically binding the data generating rules (via a rule dispatcher engine 202) to a table of the database. For example, rule dispatcher engine 202 may be configured to automatically bind the data generating rules 402 to one or more columns of table 502, as shown in FIG. 5.

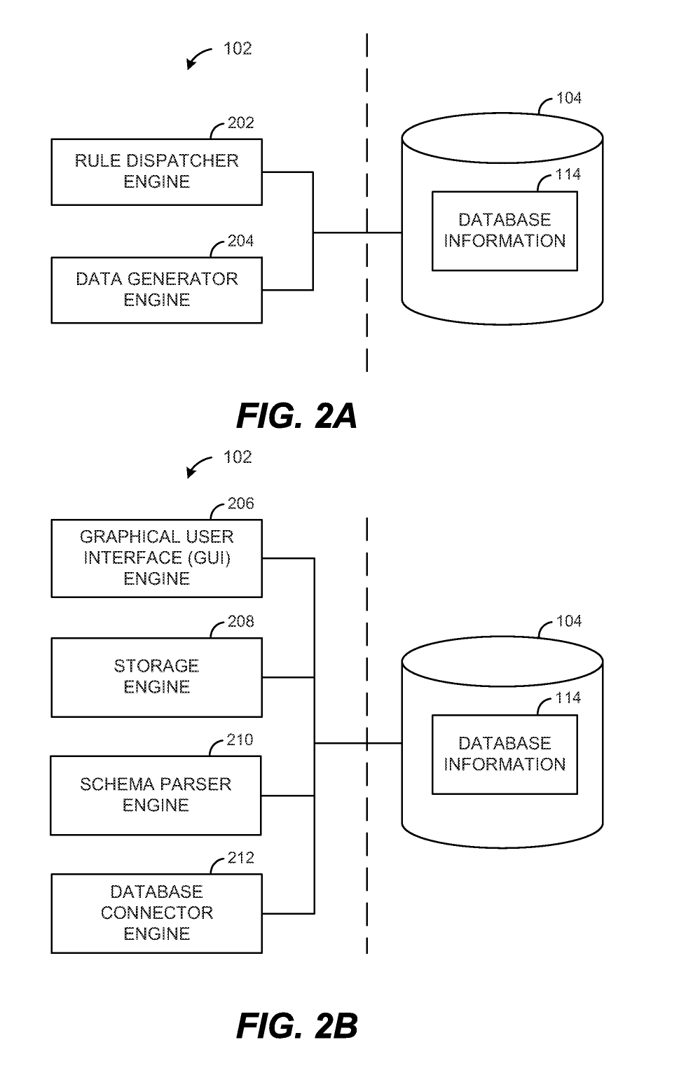

COMPONENTS: FIGS. 2A-5 depicts examples of physical and logical components for implementing various embodiments. FIG. 2A depicts rule-based data population system 102 including rule dispatcher engine 202 and data generator engine 204. FIG, 2A also depicts rule-based data population system 102 coupled to data store 104. Data store 104 may include database information 114.

Rule dispatcher engine 202 represents generally any combination of hardware and programming configured to automatically bind data generating rules to a database. The data generating rules may be automatically bound to the database tables and the database columns. The data generating rules describe the type and scope of data to be generated for testing the database. The data generating rules may include rule templates and data constraints such as ERDs and logic defined in software programs corresponding to the database (e.g., business logic defined in software programs). The data generating rules may be created from existing data (e.g., stored in data store 104), historical testing data, data patterns and trends, or a combination thereof. Alternately, or in addition, the data generating rules may be user defined (e.g., provided as input by a software architect and/or a performance tuning architect). The user defined rules may include database-level rules, table-level rules, column-level rules, or any combination thereof. Database-level rules describe ratios between tables of the database and may include, for example, industry value type, encoding information, database maximum size, and business rules. Table-level rules describe the relationships of the columns of the same table and may include, for example, table maximum size, table relationships, and table dependencies. Column-level rules describe the data format of each column and may include, for example, data pattern, column relationships, and column dependencies.

In addition to automatically binding the data generating rules, the rule dispatcher engine 202 may further automatically bind database rules, where the database rules include basic rules and advanced rules. Basic rules are database constraints from database instance and may include, for example, size, type, null values, restricted values, available values, primary key, foreign key, unique key, index value, and sample data. Advance rules include, for example, data trends, data frequencies, historical data, data priorities, data scope, and data patterns.

The following sample code shows how rules may be defined according to an embodiment and is described below:

{“rules”:[

| { | |
|---|---|
| | “ruleID”: “00000001”, |
| | “ruleTitle”: “records count”, |
| | “level”: “table”, |
| | “parameter”: “{0}”, |
| | “dataType”: “Numeric” |
| }, | |
| { | “ruleID”: “00000002”, |

“ruleTitle”: “String pattern”,
“level”: “column”,
“parameter”: “{0}”,
“dataType”: “String”

},
{...},‘”

]}

In the above example, two rules are defined (i.e., rules “0000001” and “00000002”). The first rule named “records count” is defined as a table-level rule having a numeric data type. The first rule is also defined as not having any required parameters. The second rule named “string pattern” is defined as a column-level rule having a string data type and no parameters. It should be noted that the above sample rule definition illustrates basic rules defined for only two rules. However, more complex rules definitions may be developed for a plurality of rules. Accordingly, multiple rules ranging from simple to complex rules may be created and stored to be automatically bound to the database to generate testing data. FIG. 5 illustrates an example of automatically binding rules to a column of the database, as performed by rule dispatcher engine 202.

Referring to FIG. 5, an example of automatically binding rules to one column of the database is shown. FIG. 5 includes rule dispatcher engine 202, database table 502 (i.e., table T_USER) and a set of data generating rules 402. The table 502 includes multiple columns including USER_ID, FK_ROLE_ID, and DESCRIPTION. Rules 402 may include multiple rules. For example, rules 402 may include random string, maximum size, string format, unique ID, required (i.e., mandatory field), and trend of existing values. Thus, rules 402 may define the scope and types of data to be generated for testing the database. In an embodiment, rules 402 are mapped to several queues by column name, type, and data format. The rule dispatcher engine 202 may dispatch rules to columns by using filtering strategies (e.g., rule bound history user input, or data trends). In the example shown in FIG. 5, rules 402 are automatically bound to column USER ID of table 502. Accordingly, rules 402 control the same column to determine testing data to be generated by data generator engine 204. For example, each rule 402 controls the data format for the USER ID column In an example embodiment, if there are any conflicts between bound rules of a column, the rule with a higher priority is followed. By automatically binding rules to the database, manual effort required to bind rules to columns may be averted. For example, in enterprise software that contain hundreds of tables, thousands of table columns are automatically bound to the rules to control data populating for testing, thereby reducing manual workloads.

Referring back to FIG. 2A, rule-based data population system 102 also includes data generator engine 204 to generate testing data for the database based on the rules. Thus, data generator engine 204 generates testing data according to the bound rules. In an example embodiment, the testing data is output as SQL script files, spreadsheet files, STDF files, other script file formats, or stored (e.g., in a testing database or data store 104).

FIG. 2B depicts rule-based data population system 102 including graphical user interface (GUI) engine 206, storage engine 208, schema parser engine 210, and database connector engine 212. In the example of FIG. 2B, GUI engine 206 represents generally any combination of hardware and programming configured to receive configuration input from a user. The configuration input may include data generating rules such as rule instances, rule templates, and data constraints. In an example embodiment, GUI engine 206 is operable to configure and to monitor execution of the rule-based data population system 102. For example, a software architect may define logical data constraints of the database which describe the business logic defined in software programs through GUI 206. Further, a performance tuning architect may configure data generating rules to specify data scales of tables though GUI 206. In addition, a performance tester may execute or run the rule-based data population system 102 to generate testing data and may monitor the data population process, via GUI 206. In other words, GUI 206 provides user interaction with the rule-based data population system 102.

Storage engine 208 represents generally any combination of hardware and programming configured to store data related to rule-based data population system 102. For example, storage engine 208 may store system data including database schema, data generating rule templates, and data generating rule instances. Further, storage engine 208 may store data generated by any of the engines of the system 102.

Schema parser engine 210 represents generally any combination of hardware and programming configured to parse data constraints from the database into a unified format usable by data generator engine 204. In an embodiment, schema parser engine 210 creates data generating rules from existing data or from data trends. For example, schema parser engine 210 may be coupled to a database schema to retrieve database constraints stored therein. The database constraints my include ERDs that define the structure of the database. The database constraints may subsequently be parsed for use by the data generator engine 204 for generating testing data. Alternately, or in addition, schema parser engine 210 may create data generating rules from stored data (e.g., from data store 104), from data trends and data patterns observed over time, or a combination thereof.

Database connector engine 212 represents generally any combination of hardware and programming configured to retrieve information related, to the database, retrieve testing data, and to manipulate the testing data. In an embodiment, database connector engine 212 is coupled to the database schema to acquire database information e.g., database constraints including ERDs) and to a testing data database to retrieve the generated testing data and to manipulate the testing data. Rule-based data population system 102 of FIG. 2B may also include the data store 104 to store database information, where the database information includes database schema and the data generating rules. It should be noted that the database schema and the testing data may both be stored, in the data store 104 or may be stored, separately in respective databases (e.g., database schema database and testing data database).

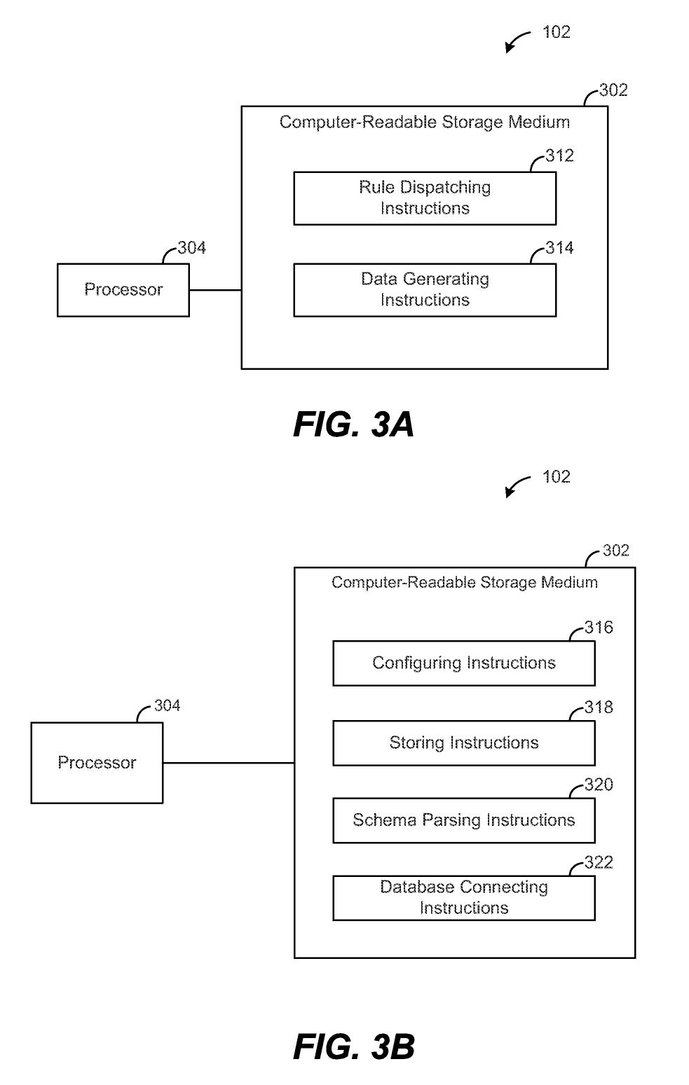

In foregoing discussion, engines 202-204 of FIG. 2A and engines 206-212 of FIG. 2B were described as combinations of hardware and programming. Such components may be implemented in a number of fashions. Looking at FIGS. 3A and 3B, the programming may be processor executable instructions stored on tangible, non-transitory computer-readable storage medium 302 and the hardware may include processor 304 for executing those instructions. Processor 304, for example, can include one or multiple processors. Such multiple processors may be integrated in a single device or distributed across devices. Computer-readable storage medium 302 can be said to store program instructions that when executed by processor 304 implements system 102 of FIGS. 2A-2A. Medium 302 may be integrated in the same device as processor 304 or it may be separate but accessible to that device and processor 304.

In one example, the program instructions can be part of an installation package that when installed can be executed by processor 304 to implement system 102. In this case, medium 302 may be a portable medium such as a CD, DVD, or flash drive or a memory maintained by a server from which the installation package can be downloaded and installed. In another example, the program instructions can be part of an application or applications already installed. Here, medium 302 can include integrated memory such as hard drive, solid state drive, or the like.

In FIG. 3A, the executable program instructions stored in medium 302 are represented as rule dispatching instructions 312 and data generating instructions 314 that when executed. by processor 304 implement rule-based data population system 102 of FIG. 2A. Rule dispatching instructions 312 represent program instructions that when executed function as rule dispatcher engine 202. Data generating instructions 314 represent program instructions that when executed implement data generator engine 204.

In FIG. 3B, the executable program instructions stored in medium 302 are represented as configuring instructions 316, storing instructions 318, schema parsing instructions 320, and database connecting instructions 322 that when executed by processor 304 implement rule-based data population system 102 of FIG. 2B. Configuring instructions 316 represent program instructions that when executed function as GUI engine 206. Storing instructions 318 represent program instructions that when executed. implement storage engine 208. Schema parsing instructions 320 represent program instructions that when executed implement schema parser engine 210, Database connecting instructions 322 represent program instructions that when executed implement database connector engine 212.

Referring to FIG. 4, an example implementation of the rule-based data population system 102 of FIGS. 2A-2B is shown. FIG. 4 includes GUI 206 for configuring the system 102, rule dispatcher 202, data generator 204, schema parser 210, and repository 208. Using the GUI 206, a software architect and a performance tuning architect may configure the system 102. Further a performance tester (not shown) may also monitor the running of the system 102 and/or execute the system 102 to generate testing data.

To illustrate, the software architect may define logical data constraints of the database through the GUI 206. Logical data constraints describe the business logic defined in programs (i.e., software) of applications that use or implement the database. For example, the software architect may analyze data relationships defined in the programs to provide the logical constraints as data input to the system 102 via GUI 206. The logical data constraints may include rules 402 (i.e., data generating rules) and ERD rules 404. Similarly, the performance tuning architect may configure the rules 402 using GUI 206. For example, the performance tuning architect may specify data scales of the tables in the database. As another example, the performance tuning architect may select particular tables in the database to populate with testing data and set testing data scales. Accordingly, input may be provided to the system 102 by a software architect having business logical knowledge of the database and by a performance tuning architect having testing design knowledge, to generate testing data that is aligned to the customer's business. Further the configuration inputs provided may be stored, for example, in the repository 208 of the system, for reuse.

FIG. 4 also includes schema parser 210 coupled to database schema storage 406. Schema parser 210 is operable to parse data constraints of the database into a format usable by GUI 206 and usable by data generator 204. For example, parsed data constraints available to GUI 206 may be farther configured by the software architect, performance tuning architect, performance tester, or any other user. In addition, the passed data constraints are usable by the data generator 204 for generating testing data. The data constraints may be extracted from the database schema 406. The data constraints may include ERDs 404. Further, the schema parser 210 is operable to create data generating rules 402 from existing data trends, historical data, observed data patterns, or any combination thereof. The data constraints parsed by the schema parser 210, ERDs 404, and rules 402 are also stored in the repository 208.

Repository 208 is to store data for the system 102. For example, repository 208 may store the database schema, data constraints, and data generating rules. The data generating rules may include rule templates (e.g., built-in templates or provisioned template) and rule instances. Thus, the repository 208 may store any data related to the system 102 or generated by any of the modules or engines of the system 102. Data in the repository 208 may be provided to the rule dispatcher 202 for automatic binding to the database.

Rule dispatcher 202 is operable to automatically bind the data generating rules to the database. For example, the rule dispatcher 202 may automatically bind the data generating rules to one or more columns of the database, to one or more tables of the database, or any combination thereof Accordingly, testing data may be generated according to the bound rules. Further, the rule-column binding or rule-table binding may be stored (e.g., in repository 208) to be reused.

Data generator 204 is operable to generate testing data based on the bound rules. The generated testing data may be output as SQL script files, other script file formats, spreadsheet files, text files, or any combination thereof. Further, the generated testing data may be stored in testing data database 208.

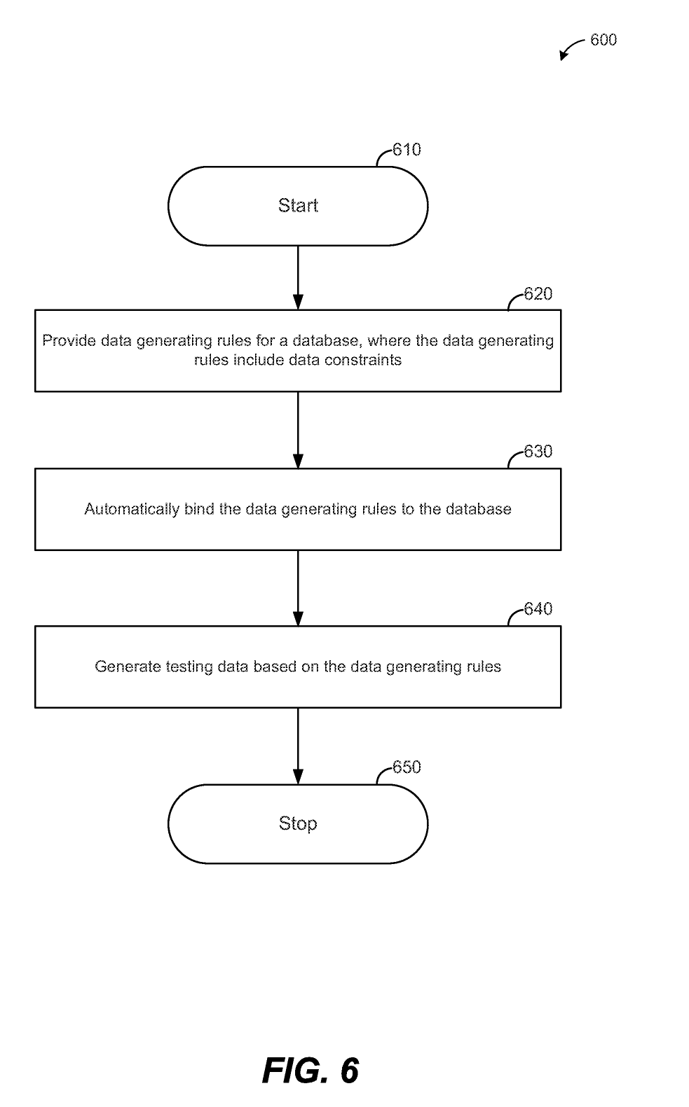

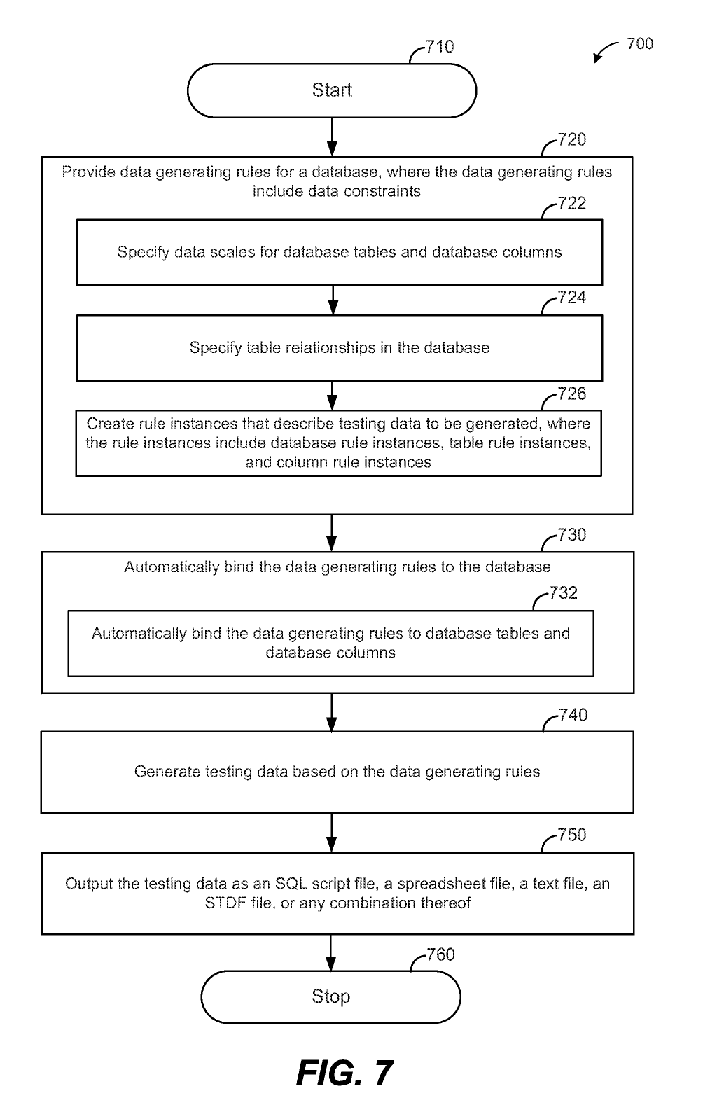

OPERATION: FIGS. 6 and 7 are example flow diagrams of steps taken to implement embodiments of a rule-based data population method. In discussing FIGS. 6 and 7, reference is made to the diagrams of FIGS. 2A, 2B, and 4 to provide contextual examples. Implementation, however, is not limited to those examples.

Starting with FIG. 6, a flowchart of an embodiment of a method 600 for rule-based data populating is described. Method 600 may start in step 610 and proceed to step 620, where data generating rules for a database are provided and where the data generating rules include data constraints. Referring to FIGS. 2A, 2B, and 4, GUI engine 208, data store 104, or repository 208 may be responsible for implementing step 620. For example, GUI engine 208 may enable a user (e.g., a software architect, a performance tuning architect, or a performance tester) to provide data generating rules. Alternately, or in addition, data store 104 and/or repository 208 may provide the data generating rules.

Method 600 also includes step 630, where the data generating rules are automatically bound to the database. Referring to FIGS. 2A and 4, the rule dispatcher engine 202 may be responsible for implementing step 630. For example, the rule dispatcher engine 202 may automatically bind the data generating rules to the database. The data generating rules may be automatically bound to database columns, database tables, or a combination thereof.

Method 600 may proceed to step 640, where testing data is generated based on the data generating rules. Referring to FIGS. 2A and 5, data generator engine 204 may be responsible for implementing step 640, For example, data generator engine 204 may generate the testing data based on the bound data generating rules. Thus, testing data is generated according to the data generating rules. Method 600 may then proceed to step 650, where the method stops.

FIG. 7 depicts a flowchart of an embodiment of a method 700 for rule-based data population. Method 700 may start in step 710 and proceed to step 720, where data generating rules for a database are provided, where the data generating rules include data constraints. Step 720 may further include step 722, where data scales for database tables and database columns are specified, step 724, where table relationships in the database are specified, and step 726, where rule instances that describe testing data to be generated are created. The rule instances include database rule instances, table rule instances, and column rule instances. Referring to FIGS. 2A-2B and 4, GUI engine 208, data store 104, or repository 208 may be responsible for implementing steps 720, 722, and 724. For example, GUI 208 may receive user configuration inputs such as data generating rules. Moreover, the data generating rules may be stored in data store 104 or repository 208 and provide the data generating rules. Rule dispatcher engine 202 may be responsible for implementing step 726 of creating rule instances that describe testing data to be generated. For example, the rule instances may be created built-in rule templates for the stored database schema in the repository 208.

Method 700 may proceed to step 730, where the data generating rules are automatically bound to the database. Step 730 may further include step 732, where the data generating rules are automatically bound to database tables and to database columns. Referring to FIGS. 2A and 4, the rule dispatcher engine 202 may be responsible for implementing steps 730 and 732.

Method 700 may proceed to step 740, where testing data is generated based on the data generating rules. Referring to FIGS. 2A and 5, data generator engine 204 may be responsible for implementing step 740. Thus, data generating rules are generated according to the bound data generating rules.

Method 700 may proceed to step 750, where the testing data is output as an SQL script file, an STDF file, a spreadsheet file, a text file, or any combination thereof. Referring to FIGS. 2A and 4, the data generator engine 204 may be responsible for implementing step 750. For example, the data generator engine 204 may store the testing data as script files, spreadsheet files, or text files in the data store 104 or in the testing data database 408 of FIG. 4. Method 700 may then proceed to step 760, where the method 700 stops.

CONCLUSION: FIGS. 1-5 depict the architecture, functionality, and operation of various embodiments. In particular, FIGS. 2-5 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any computer-readable medium for use by or in connection with an instruction execution system such as a computer/processor based system or an ASIC (Application Specific Integrated Circuit) or other system that can fetch or obtain the logic from computer-readable medium and execute the instructions contained therein. “Computer-readable medium” can be any individual medium or distinct media that can contain, store, or maintain a set of instructions and data for use by or in connection with the instructions execution system. A computer-readable medium can comprise any one or more of many physical, non-transitory media such as, for example, electronic, magnetic, optical, electromagnetic, or semiconductor device. More specific examples of a computer-readable medium include, but are not limited to, a portable magnetic computer diskette such as floppy diskettes, hard drives, solid state drives, random access memory (RAM), read-only memory (ROM), erasable programmable read-only memory, flash drives, and portable compact discs.

Although the flow diagrams of FIGS. 6-7 show specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A rule-based data population system, the system comprising:
a rule dispatcher engine to automatically bind data generating rules to a database; and
a data generator engine to generate testing data for the database based on the rules.

2. The system of claim 1, further comprising:
a graphical user interface (GUI) engine to receive configuration input from a user, wherein the configuration input includes the data generating rules and wherein the data generating rules include rule instances, rule templates, and data constraints;
a storage engine to store database information, wherein the database information include database schema and the data generating rules; and
a schema parser engine to parse the data constraints from the database into a unified format usable by the data generator engine.

3. The system of claim 2, wherein the schema parser engine is further to create data generating rules from stored data, historical testing data, or a combination thereof.

4. The system of claim 2, wherein the data constraints include logical data constraints of the database corresponding to logic defined in executable programs related to the database and wherein the data constraints include entity relationship diagrams (ERDs).

5. The system of claim 2, further comprising a database connector engine to:
retrieve information related to the database;
retrieve the testing data; and
manipulate the testing data.

6. The system of claim 1, wherein the rule dispatcher engine is further to automatically bind database rules, wherein the database rules include basic rules and advanced rules.

7. The system of claim 6, wherein the basic rules include data information including data size, data type, null data values, restricted data values, available data values, primary key, foreign key, unique key, index, sample data, data formats, or any combination thereof.

8. The system of claim 6, wherein the advance rules include data trends, data frequency, historical data, data priorities, data scope, data patterns, or any combination thereof.

9. The system of claim 1, wherein the rule dispatcher engine is further to automatically bind user defined rules, wherein the user defined rules include database-level rules, table-level rules, column-level rules, or any combination thereof.

10. The system of claim 9, wherein the database-level rules include industry value type, encoding information, database maximum size, business rules, or any combination thereof.

11. The system of claim 9, wherein the table-level rules include table maximum size, table relationships, table dependencies, or any combination thereof.

12. The system of claim 9, wherein the column-level rules include data pattern, column relationships, column dependencies, or any combination thereof.

13. A non-transitory computer readable medium comprising instructions that when executed implement a rule-based data population method for testing a database, the method comprising:
providing rules for generating testing data for the database;
automatically bind the rules to the database; and
generating testing data based on the bound rules.

14. The non-transitory computer readable medium of claim 13, wherein the rules include data constraints comprising entity relation diagrams (ERDs).

15. The non-transitory computer readable medium of claim 13, wherein automatically binding the rules to the database includes binding the rules to database tables, database columns, or a combination thereof.

16. The non-transitory computer readable medium of claim 13, further comprising outputting the testing data as a structured query language (SQL) script file, a spreadsheet file, a text file, a standard tester data format (STDF) file, other script file formats, or any combination thereof.

17. The non-transitory computer readable medium of claim 13, wherein providing the rules comprises:
specifying data scales for database tables and database columns; and
specifying table relationships in the database.

18. The non-transitory computer readable medium of claim 13, wherein providing the rules comprises creating rule instances that describe the testing data to be generated, wherein the rule instances include database rule instances, table rule instances, and column rule instances.

19. A rule-based data population method for testing a database, the method comprising:
providing data generating rules for the database, wherein the data generating rules include data constraints;
automatically binding the data generating rules to the database; and
generating testing data based on the data generating rules.

20. The method of claim 19, further comprising creating a script based on the testing data.
